(19) United States
(12) Patent Application Publication
(10) Pub. No.: US 2007/0047665 A1
(43) Pub. Date: Mar. 1, 2007

(54) Methods and systems for communicating signals through multi-carrier systems

(76) Inventor: Daniel H. Friend, Christiansburg, VA (US)

Correspondence Address: MOTOROLA, INC., LAW DEPARTMENT, 1303 E. ALGONQUIN ROAD, SCHAUMBURG, IL, 60196, US

(21) Appl. No.: 11/211,287

(22) Filed: Aug. 25, 2005

(51) Int. Cl. H04K 1/10

(52) U.S. Cl. 375/260

(57) ABSTRACT

Methods and systems for communicating a signal through a multi carrier system session are disclosed. The carrier channel includes a plurality of subcarriers. A bit value for each subcarrier of the plurality of subcarriers is determined (202, 402) based on the signal to be communicated. The plurality of subcarriers is divided (204, 404) into a first set of subcarriers and a second set of subcarriers based on the bit value for each subcarrier of the plurality of subcarriers. The first set of subcarriers is turned off (206, 406). The second set of subcarriers is then modulated (208, 408).

### FIELD OF THE INVENTION

This invention relates in general to multi-carrier systems, and more specifically, to transmission and reception of signals through a multi-carrier system.

### BACKGROUND OF THE INVENTION

Existing systems employing multiple carriers, for example, Orthogonal Frequency Divisional Multiplexing (OFDM) systems make use of higher order modulation techniques to increase bandwidth efficiency. Examples of such modulation techniques include 16-Quadrature Amplitude Modulation (16-QAM) and 16-Phase Shift Keying (16-PSK). However, these techniques are sensitive to frequency, timing and phase errors.

The higher order modulation techniques also require higher signal to noise ratios. In addition, use of the higher order modulation techniques may result in high Peak to Average Power Ratios (PAPR), which leads to low power amplifier efficiency.

The existing multi-carrier systems are deployed in frequency selective fading environments. In a frequency selective fading environment, certain frequencies are prone to severe attenuation, leading to one or more of the subcarriers employed by the system being unrecoverable. Further, the OFDM systems reduce the bandwidth that is available to a communications link by using a part of the bandwidth for transmitting pilot signals.

### BRIEF DESCRIPTION OF THE DRAWINGS

Representative elements, operational features, applications and/or advantages of the present invention reside inter alias in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 illustrates an environment in which various embodiments of the present invention may be practiced.

FIG. 2 is a flowchart illustrating a method for communicating a signal, in accordance with an embodiment of the invention.

FIG. 3 is a block diagram of an exemplary system for communicating a signal, in accordance with an embodiment of the invention.

FIG. 4 is a flowchart illustrating a method for communicating a signal, in accordance with another embodiment of the invention.

FIG. 5 is block diagram of another exemplary system for communicating a signal, in accordance with an embodiment of the invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF THE INVENTION

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely ‘Methods and Systems for Communicating Signals through Multi-Carrier Systems’, is provided as a specific enabling disclosure that may be generalized to any application of the disclosed system, device and method for communicating a signal in accordance with various embodiments of the present invention.

Embodiments of the invention relate to methods and systems for communicating signals through multi-carrier systems. A multi-carrier system includes a plurality of carrier channels each of which employs multiple subcarriers. Examples of a multi-carrier system include, but are not limited to, a Frequency Division Multiplexing (FDM) system and an Orthogonal Frequency Division Multiplexing (OFDM) system. In the multi-carrier system, signals are transmitted by modulating the subcarriers. Further, some subcarriers are used to transmit pilot signals. Exemplary modulation techniques include, but are not limited to Phase Shift Keying (PSK) and Quadrature Amplitude Modulation (QAM).

FIG. 1 illustrates an environment 100 in which various embodiments of the invention may be practiced. In this environment, a signal can be transmitted by a mobile communication device 102 and received by a base transceiver station (BTS) 104. The signal can also be transmitted by the BTS 104 and received by the mobile communication device 102. The signal may be transmitted and received by using the multi-carrier system, for example, the Orthogonal Frequency Divisional Multiplexing (OFDM) system.

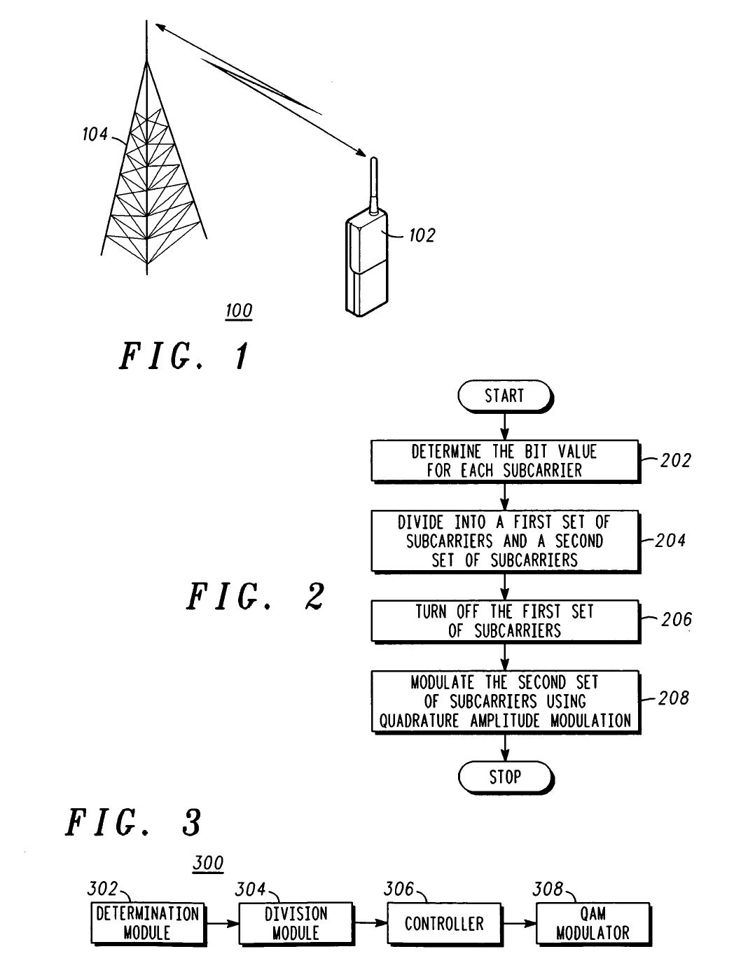

For the purpose of communicating the signal, a binary vector of length N containing K ones and N-K zeros is assigned to the subcarriers of a carrier channel of the multi-carrier system. The number of bits in the binary vector is equal to the number of subcarriers in the carrier channel. Each subcarrier is associated with a distinct bit of the binary vector. FIG. 2 is a flowchart illustrating a method for communicating the signal, in accordance with an exemplary embodiment of the invention. At step 202, the bit value for each subcarrier of the carrier channel is determined. The bit value for each subcarrier can equal either zero or one. The bit value for each subcarrier depends on the signal to be transmitted. Information bits from the data/signal to be transmitted are mapped to a binary vector. For example, a binary vector of length N=8 with K=4 allows 70 possible combinations of binary vectors of length 8 with 4 ones. An information word of length 6 bits (i.e. a 6-bit symbol) would map to one of the 70 possible binary vectors. In this example, not all 70 possible binary vectors would be mapped since there are only 64 possible one-to-one mappings. Note that this means the fractional part of log₂70 (i.e. 0.13 bits) may be thrown away to simplify the system. Additional bits from the data/signal to be transmitted are used to modulate the individual subcarriers which are ON for the case where QAM modulation is applied to ON subcarriers.]. At step 204, the subcarriers are divided into a first set of subcarriers and a second set of subcarriers. This division is based on a bit value of each of the subcarriers. In this division, the subcarriers with a particular bit value are grouped together. The subcarriers having the bit value equal to zero are included in the first set of subcarriers, while the subcarriers having the bit value equal to one are included in the second set of subcarriers. Hence, the set of subcarriers corresponding to positions of the bits in the binary vector, whose bit value is zero, are included in the first set of subcarriers. Similarly, the set of subcarriers corresponding to the positions of the bits in the binary vector, whose bit value is one, are included in the second set of subcarriers. At step 206, the first set of subcarriers is turned off. Hence, the set of subcarriers corresponding to positions of the bits in the binary vector, whose bit value is zero, are turned off. An exemplary method for turning off a particular subcarrier is to zero out the subcarrier frequency that is passed on to a modulator for modulating the signal. In other words, the frequency of the particular subcarrier is suppressed before the modulation. At step 208, the second set of subcarriers is modulated by using QAM. This implies that the set of subcarriers corresponding to the positions of the bits in the binary vector, whose bit value is one, are modulated.

The method described above will now be illustrated using an example of the multi-carrier system that includes the carrier channel employing a set of N subcarriers, where N is an integer greater than or equal to two. At step 202, the bit value for each of the N subcarriers is determined based on the signal to be transmitted. If K subcarriers out of the N subcarriers are assigned the bit value of one and the remaining subcarriers (N-K) are assigned the bit value of zero, the resulting binary vector is an N-bit binary vector with K bits equal to one and N-K bits equal to zero. At step 204, the N subcarriers are divided into the first set of subcarriers and the second set of subcarriers. In this example, the first set of subcarriers includes N-K subcarriers and the second set of subcarriers includes K subcarriers. At step 206, the first set of subcarriers is turned off. At step 208, the second set of subcarriers is modulated by using QAM. Therefore, the multi-carrier system includes K ON subcarriers that are modulated, and N-K OFF subcarriers. In one embodiment of the invention, the value of K is chosen to be half of N, or K=N/2.

For the purpose of communicating the signal, the signal is divided into discrete parts. Each discrete part is represented by a combination of binary bits. The representation is referred to as a symbol. Therefore, the signal is communicated in the form of symbols. In the above example, for the symbols to be communicated, the number of possible combinations of K ON subcarriers and N-K OFF subcarriers in the set of N subcarriers is given by:
C=N!/(K!(N-K)!) (1)
The throughput in terms of bits per symbol for the system illustrated above is:
T=BK+log₂(C) (2)
where B is the number of bits per subcarrier modulation symbol.

A technique for demodulating the signal will now be explained. Referring back to FIG. 1, for the case where the signal is transmitted by the mobile communication device 102 and received by the BTS 104, the following occur at the BTS 104. A first symbol is generated based on the first set of subcarriers. For this purpose, the BTS 104 has a predefined map. The predefined map includes information regarding which symbol is to be generated for a particular combination of the subcarriers that are turned off. Based on this information, the first symbol is generated in the BTS 104. Demodulation is performed on the second set of subcarriers to generate a second symbol. The BTS 104 will combine the first symbol and the second symbol to obtain the output symbol.

FIG. 3 is a block diagram of an exemplary system 300 for communicating the signal, in accordance with an embodiment of the invention. The system includes a determination module 302, a division module 304, a controller 306, and a QAM modulator 308. The signal is provided to the determination module 302. The determination module 302 determines the bit value for each subcarrier based on the signal. The bit value for each subcarrier may be determined by mapping an information symbol to a binary vector of length N (as in the previous example where a 6-bit symbol was mapped to a binary vector of length 8). The individual bits in the binary vector correspond to individual subcarriers. An exemplary method of mapping the information symbol to a binary vector is a lookup table. However, the use of a lookup table is not limiting of the invention. Any means of mapping the information symbol to a binary vector is within the scope of the invention. The determination module 302 assigns the bit value of either zero or one to each subcarrier. Based on the bit value of each subcarrier, the division module 304 divides the subcarriers into the first set of subcarriers and the second set of subcarriers. The subcarriers that have the bit value equal to zero are included in the first set of subcarriers and the subcarriers that have the bit value equal to one are included in the second set of subcarriers. The controller 306 turns off the first set of subcarriers. The controller 306 turns off the subcarriers included in the first set of subcarriers. Hence, the controller 306 turns off the set of subcarriers corresponding to the positions of the bits of the binary vector, which have zero value. The QAM modulator 308 modulates the second set of subcarriers using QAM.

The embodiments of the invention described above provide high bandwidth efficiency. In addition, the embodiments do not rely on order of the modulation to increase the bandwidth efficiency. Therefore, the high bandwidth efficiency is not accompanied by an increased sensitivity to phase errors. Further, the method and system reduce inter-subcarrier-interference and increase robustness in frequency selective fading channels.

In another embodiment of the invention, the signal is communicated through a multi-carrier system by applying Newman phases to a signal modulated with non-coherent combinatorial on-off keying (COOK). The embodiment is described below.

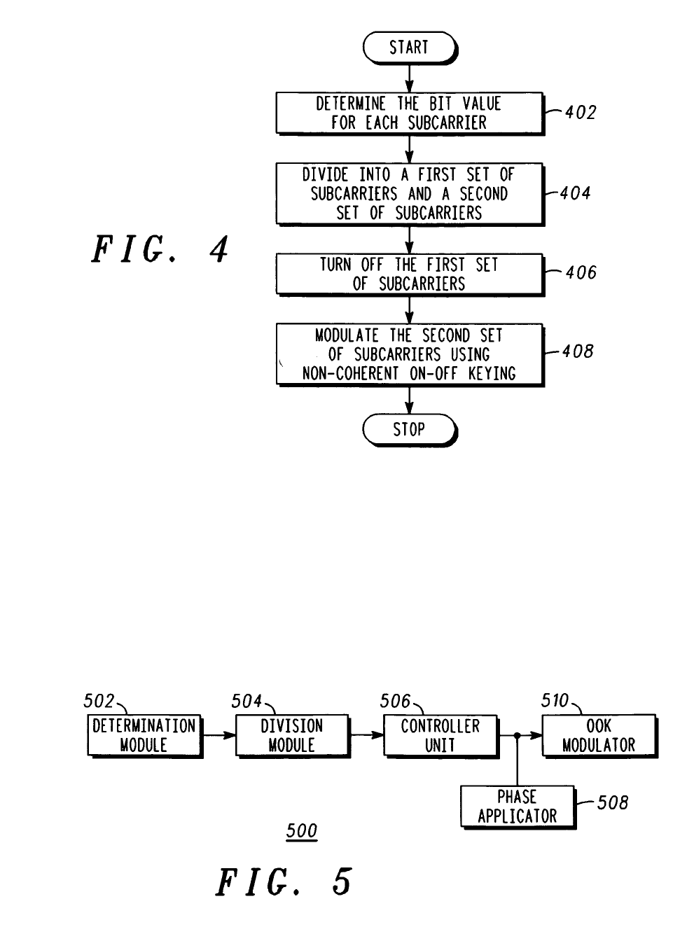

FIG. 4 is a flowchart illustrating a method for communicating the signal, in accordance with an exemplary embodiment of the invention. At step 402, the bit value for each subcarrier of the carrier channel is determined. The bit value for each subcarrier can equal either zero or one. The bit value for each subcarrier depends on the signal to be communicated. At step 404, the plurality of subcarriers is divided into the first set of subcarriers and the second set of subcarriers. This division is based on the bit value of each of the subcarriers. In this division, the subcarriers with identical bit values are grouped together. The subcarriers having the bit value equal to zero are included in the first set of subcarriers while the subcarriers having the bit value equal to one are included in the second set of subcarriers. Hence, the set of subcarriers corresponding to positions of the bits in the binary vector, whose bit value is zero, are included in the first set of subcarriers. Similarly, the set of subcarriers corresponding to the positions of the bits in the binary vector, whose bit value is one, are included in the second set of subcarriers. At step 406, the first set of subcarriers is turned off. Hence, the set of subcarriers corresponding to positions of the bits in the binary vector, whose bit value is zero, are turned off. An exemplary method for turning off a particular subcarrier is to zero out the subcarrier frequency that is passed on to a modulator for modulating the signal. In other words, the frequency of the particular subcarrier is suppressed before the modulation. At step 408, the second set of subcarriers is modulated using non-coherent on-off keying. For this purpose, a set of Newman phases is applied to the second set of subcarriers. Non-coherent combinatorial on-off keying involves turning off certain subcarriers while keeping other subcarriers on in response to a particular signal without modulating any of the subcarriers individually. The keying is non-coherent as it does not transmit a pilot signal and does not depend on coherent phase reference.

The method described above will now be illustrated using an example of the multi-carrier system that includes the carrier channel employing the set of N subcarriers, where N is an integer greater than or equal to two. At step 402 the bit value for each of the N subcarriers is determined based on the signal to be transmitted. If K subcarriers out of the N subcarriers are assigned the bit value of one and the remaining subcarriers (N-K) are assigned the bit value of zero, the resulting binary vector is an N-bit binary vector with K bits equal to one and N-K bits equal to zero. At step 404, the plurality of subcarriers is divided into a first set of subcarriers and a second set of subcarriers. Hence, the first set of subcarriers includes N-K subcarriers and the second set of subcarriers includes K subcarriers. At step 406, the first set of subcarriers is turned off. At step 408, Newman phases are applied to the second set of subcarriers that is modulated using non-coherent on-off keying. Therefore, the multi-carrier system includes K ON subcarriers that are modulated, and N-K OFF subcarriers. In one embodiment of the invention, the value of K is chosen to be half of N, or K=N/2.

For the purpose of communicating the signal, the signal is divided into discrete parts. Each discrete part is represented by a combination of binary bits. The representation is referred to as a symbol. Therefore, the signal is communicated in the form of symbols. In the above example, for the symbols to be communicated, the number of possible combinations of K ON subcarriers and N-K OFF subcarriers in the set of N subcarriers is given by:
C=N!/(K!(N-K)!) (3)
The throughput in terms of bits per symbol is
T=log₂(C) (4)

A technique for demodulating the signal will now be explained. For example, for the case where the signal is transmitted by the mobile communication device 102 and received by the BTS 104, the following occur at the BTS 104. An output symbol is generated based on the combination of the subcarriers that are turned off. For this purpose, the BTS 104 has a predefined map, which includes information regarding which symbol is to be generated for a particular combination of the subcarriers that are turned off. Based on this information, the output symbol is generated in the BTS 104.

FIG. 5 is a block diagram of an exemplary system 500 for communicating the signal, in accordance with an embodiment of the invention. The system includes a determination unit 502, a division unit 504, a controller unit 506, a phase applicator 508, and an OOK modulator 510. The signal is provided to the determination unit 502. The determination unit 502 uses the signal to determine the bit value of for each subcarrier. The bit value for each subcarrier may be determined by mapping an information symbol to a binary vector of length N (as in the previous example where a 6-bit symbol was mapped to a binary vector of length 8). The individual bits in the binary vector correspond to individual subcarriers. An exemplary method of mapping the information symbol to a binary vector is a lookup table. However, the use of a lookup table is not limiting of the invention. Any means of mapping the information symbol to a binary vector is within the scope of the invention. For non-coherent COOK, all data to be transmitted may be mapped to these length N binary vectors since no further modulation is performed on the individual subcarriers. The determination unit 502 assigns a bit value of either zero or one to each subcarrier. Based on the bit value of each subcarrier, the division unit 504 divides the subcarriers into the first set of subcarriers and the second set of subcarriers. The subcarriers that have the bit value equal to zero are included in the first set of subcarriers, and the subcarriers that have the bit value equal to one are included in the second set of subcarriers. The controller unit 506 turns off the subcarriers included in the first set of subcarriers. Hence, the controller unit 506 turns off the set of subcarriers corresponding to positions of the bits of the binary vector, which have zero value. The phase applicator 508 applies a set of Newman phases to each subcarrier included in the second set of subcarriers. An OOK modulator 510 modulates the second set of subcarriers using non-coherent on-off keying.

The embodiments of the invention that relate to non-coherent combinatorial on-off keying (COOK) modulation have high bandwidth efficiency. The embodiments provide pilot-less modulation as none of the subcarriers are reserved for pilot signals, and are insensitive to errors in phase tracking. Additionally, the amount of transmit power available per subcarrier increases since only a part of the subcarriers are ON during any transmission. Further, peak to average power ratio (PAPR) is reduced which allows the power amplifier to operate more efficiently.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A method for communicating a signal through a carrier channel, the carrier channel having a plurality of subcarriers, the method comprising:
determining a bit value for each subcarrier of the plurality of subcarriers based on the signal to be communicated;
dividing the plurality of subcarriers into a first set of subcarriers, and a second set of subcarriers based on the bit value for each subcarrier of the plurality of subcarriers;
turning off the first set of subcarriers; and
modulating the second set of subcarriers using quadrature amplitude modulation.

2. The method of claim 1, wherein number of subcarriers in the first set of subcarriers equals the number of subcarriers in the second set of subcarriers.

3. The method of claim 1, further comprising:
generating a first symbol based on the first set of subcarriers;
generating a second symbol based on the second set of subcarriers; and
combining the first symbol and the second symbol to obtain an output symbol.

4. A method for communicating a signal through a carrier channel, the carrier channel having a plurality of subcarriers, the method comprising:
determining a bit value for each subcarrier of the plurality of subcarriers based on the signal to be communicated;
dividing the plurality of subcarriers into a first set of subcarriers, and a second set of subcarriers based on the bit value for each subcarrier of the plurality of subcarriers;
turning off the first set of subcarriers; and
modulating the second set of subcarriers using non-coherent on-off keying.

5. The method of claim 4, further comprising applying a set of Newman phases to the second set of subcarriers.

6. The method of claim 4, wherein number of subcarriers in the first set of subcarriers equals the number of subcarriers in the second set of subcarriers.

7. The method of claim 4, further comprising generating an output symbol based on the combination of the first set of subcarriers and the second set of subcarriers.

8. A system for communicating a signal through a carrier channel, the carrier channel having a plurality of subcarriers, the system comprising:
a determination module capable of determining a bit value for each subcarrier of the plurality of subcarriers based on the signal to be communicated;
a division module capable of dividing the plurality of subcarriers into a first set of subcarriers, and a second set of subcarriers based on the bit value for each subcarrier of the plurality of subcarriers;
a controller capable of turning off the first set of subcarriers; and
a quadrature amplitude modulation (QAM) modulator capable of modulating the second set of subcarriers using quadrature amplitude modulation.

9. The system of claim 8, wherein number of subcarriers in the first set of subcarriers equals the number of subcarriers in the second set of subcarriers.

10. A system for communicating a signal through a carrier channel, the carrier channel having a plurality of subcarriers, the system comprising:
a determination module capable of determining a bit value for each subcarrier of the plurality of subcarriers based on the signal to be communicated;
a division module capable of dividing the plurality of subcarriers into a first set of subcarriers, and a second set of subcarriers based on the bit value for each subcarrier of the plurality of subcarriers;
a controller capable of turning off the first set of subcarriers; and
an on-off keying (OOK) modulator capable of modulating the second set of subcarriers using non-coherent on-off keying.

11. The system of claim 10, wherein number of subcarriers in the first set of subcarriers equals the number of subcarriers in the second set of subcarriers.

12. The system of claim 10, further comprising a phase applicator capable of applying a set of Newman phases to the second set of subcarriers.
